(19) United States
(12) Patent Application Publication
(10) Pub. No.: US 2016/0255865 A1
(43) Pub. Date: Sep. 8, 2016

(54) PROTEIN-CONTAINING DIETARY COMPOSITIONS AND METHODS FOR THEIR PREPARATION AND USE

(71) Applicant: BENEMILK OY, Raisio (FI)

(72) Inventors: Feng Wan, Issaquah, WA (US); Ilmo Pellervo Aronen, Hinnerjoki (FI); Merja Birgitta Holma, Raisio (FI); Christopher John Buntel, Singapore (SG)

(73) Assignee: Benemilk Oy, Raisio (FI)

(21) Appl. No.: 15/029,219

(22) PCT Filed: Oct. 15, 2013
(86) PCT No.: PCT/US13/65046

§ 371 Date: Apr. 13, 2016

(51) Int. Cl. A23K 20/158; A23K 20/174; A23K 50/10; A23K 20/105; A23K 20/163; A23K 20/20; A23K 20/147; A23K 20/142

(52) U.S. Cl. CPC A23K 20/158; A23K 20/147; A23K 20/174; A23K 20/142; A23K 20/105; A23K 20/163; A23K 20/20; A23K 50/10

(57) ABSTRACT

Dietary compositions containing at least one protein component are described herein, as well as methods for their preparation and use. A premix dietary composition may include a fatty acid component and a protein component. The fatty acid component may include at least about 90% saturated fatty acid by weight. The fatty acid component may be present in the dietary composition in an amount of at least about 10% by weight of the dietary composition.

### BACKGROUND

Increasing production and fat content of milk obtained from lactating ruminants has been a major goal for dairy farmers. Additional milk production per ruminant is beneficial because it results in a higher yield, thereby increasing profits. Increased milk fat is desirable because it has a higher economic value and can be used in highly desirable food products, such as cheese, yogurt, and the like.

A common approach to increasing either or both production and milk fat content includes adjusting feed, nutrients, elements, vitamins, supplements, and/or the like provided to the ruminant. One such specific method includes feeding the ruminant a total mixed ration (TMR), which is a mix of grain and silage with some protein meals, such as, for example, soya bean meal and canola meal. Additional materials and trace elements, vitamins, extra nutrients, and the like may also be added to the TMR.

However, the current methods and feeds used to increase milk fat content tend to lower milk production, lower protein content, and/or have other detrimental effects on the ruminant. Furthermore, the methods and feeds often result in other undesired effects, such as increased trans fatty acid levels on the fatty acid profile of the milk fat.

### SUMMARY

In an embodiment, a premix dietary composition may include a fatty acid component and a protein component. The fatty acid component may include at least about 90% saturated fatty acid by weight. The fatty acid component may be present in the dietary composition in an amount of at least about 10% by weight of the dietary composition.

In an embodiment, a method of preparing a premix dietary composition for ruminants may include combining a fatty acid component and a protein component to form a mixture. The fatty acid component may include at least about 90% saturated fatty acid by weight. The fatty acid component may be present in the dietary composition in an amount of at least about 10% by weight of the dietary composition.

In an embodiment, a method of increasing milk fat content in ruminants may include combining a premix dietary composition with a feed to obtain a mixture and providing the mixture to a ruminant for ingestion. The premix dietary composition may include a fatty acid component and a protein component. The fatty acid component may include at least about 90% saturated fatty acid by weight. The fatty acid component may be present in the dietary composition in an amount of at least about 10% by weight of the dietary composition.

In an embodiment, a premix composition for ruminants may include a fatty acid component and a protein component. The fatty acid component may include a palmitic acid compound in an amount of at least about 90% by weight of the fatty acid component. The protein component may include an oilseed meal. The fatty acid component may be present in the premix composition in an amount of at least about 10% by weight of the premix composition. The premix composition may be configured to be mixed with a ruminant feed and provided to ruminants

### BRIEF DESCRIPTION OF THE DRAWINGS

FIG. 1 depicts a flow diagram of a method of preparing a dietary composition for ruminants according to an embodiment.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

The following terms shall have, for the purposes of this application, the respective meanings set forth below.

A ruminant is a class of mammal with a multiple chamber stomach that gives the animal an ability to digest cellulose-based food. The stomach of a ruminant has four morphologically distinct compartments: the rumen, the reticulum, the omasum, and the abomasum. Bacteria in the rumen enable the ruminant to digest cellulose-based food by softening it and regurgitating the semi-digested mass. The regurgitate, known as cud, is then chewed again by the ruminant. Specific examples of ruminants include, but are not limited to, cattle, bison, buffaloes, yaks, camels, llamas, giraffes, deer, pronghorns, antelopes, sheep, and goats. The milk produced by ruminants is widely used in a variety of dairy-based products. Dairy cows are of considerable commercial significance for the production of milk and processed dairy products such as, for example, yogurt, cheese, whey, and ice cream.

Silage refers to a feed that includes chopped green forage, such as, for example, grass, legumes, and field corn. The silage is placed in a structure or a container that is designed to exclude air. The silage is then fermented in the structure or container, thereby retarding spoilage. Silage can have a water content of about 60% to about 80% by weight.

A premix composition is a composition that contains a mixture of ingredients, such as, for example, a fatty acid component and a protein component. The premix composition can be sold, marketed, packaged, transported, and/or the like without further modification. In some embodiments, the premix composition may be combined with one or more other ingredients. Combination with one or more other ingredients may occur before or after the premix composition is sold, marketed, packaged, transported, and/or the like.

The present disclosure relates generally to dietary compositions such as feed additives, premix compositions, feeds, and the like that can be fed to ruminants for purposes of affecting milk production in the ruminant. Particularly, the dietary compositions described herein may be fed to a ruminant to increase the amount of milk produced by the ruminant and/or to increase the fat content of the milk produced by the ruminant, as described in greater detail herein.

When a ruminant consumes feed, the fat in the feed is modified by the rumen to provide a milk fat profile that is different from the profile of fat in the feed. All fats which are not completely inert in the rumen may decrease rumen digestibility of the feed material. Milk composition and fat quality can be influenced by the ruminant's diet. For example, oil feeding can have negative effects on both rumen function and milk formation. As a result of the oil feeding, the milk protein concentration is lowered, the fat concentration is decreased, and the proportion of trans fatty acids is increased. These have been connected especially to an increase in the harmful low-density lipoprotein (LDL) cholesterol and to a decrease in the beneficial high-density lipoprotein (HDL) cholesterol in human blood when the milk is consumed. In addition, the properties of the milk fat during industrial milk processing are weakened. A high level of polyunsaturated fatty acids in milk can also cause taste defects and preservation problems. A typical fatty acid composition of milk fat may contain more than 70% saturated fatty acids, and the total amount of trans fatty acids may vary in the range of 3%-10%. When vegetable oil is added into the feed, the proportion of trans fatty acids may rise to more than 10%.

One solution to diminishing the detrimental effect of oil and fat is to prevent triglyceride fat hydrolysis. Fat hydrolysis can be decreased, for example, by protecting fats with formaldehyde treated casein. Another alternative is to make insoluble fatty acid calcium salts whereby hydrogenation in rumen can be avoided. However, fatty acid salts have a pungent taste, which can limit their usability in feeds and can result in decreased feed intake. The salts may also impact the pelletizing process of the feed.

Accordingly, the dietary composition described herein allows for the transfer of palmitic acid from the feed via the digestive tract into the blood circulation of a ruminant. This improves the energy efficiency of milk production of the ruminant. When the utilization of energy becomes more efficient, the milk production increases and the concentrations of protein and fat in the milk rise. Especially, the dietary composition enhances fat synthesis in the mammary gland by bringing milk fat components to the cell and therefore the energy consuming synthesis in the mammary gland may not be necessary. Thus, glucose may be more efficiently used for lactose production whereupon milk production increases. The milk protein content rises since there may be no need to produce glucose from amino acids. Thus, the ruminant may not lose as much weight at the beginning of the lactation period.

In the various embodiments described herein, the dietary compositions may include at least a fatty acid component and a protein component. The fatty acid component may be primarily saturated fatty acid (such as palmitic acid) and may contain little or no unsaturated trans fatty acid, as described in greater detail herein. The fatty acid component may be present in the dietary composition in an amount of at least about 10% by weight of the dietary composition, including, for example, about 10% to about 80%, about 10% to about 50%, about 10% to about 60%, or about 10% to about 90% by weight of the composition. The protein component may be present in the dietary composition in an amount of less than or equal to about 90% by weight for the dietary composition including, for example, about 20% to about 70%, about 10% to about 40%, or about 50% to about 70% by weight of the dietary composition. In some embodiments, the compositions described herein may be used as a booster or a supplement to other feed, such as a premix composition or the like.

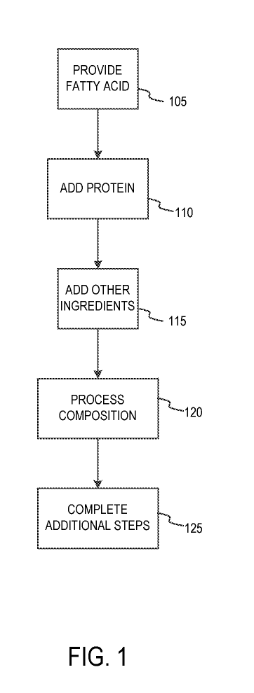

FIG. 1 depicts a flow diagram of a representative method of preparing a dietary composition for a ruminant. In various embodiments, the dietary composition may be formulated in a manner so that when consumed by the ruminant, the dietary composition maximizes particular qualities in the milk produced by the ruminant, as well as an amount of milk produced by the ruminant, as described in greater detail herein. In particular embodiments, the dietary composition may be substantially a solid dietary composition, including, but not limited to, a capsule, a tablet, a pellet, or a granular material.

In various embodiments, the components described herein with respect to FIG. 1 may generally be combined in any order and/or any combination, and are not limited by the order described herein. In some embodiments, a dietary composition may be prepared by providing 105 a fatty acid component and adding 110 a protein component to the fatty acid component. Thus, processes 105 and 110 result in combining the fatty acid component to the protein component to obtain a mixture. In some embodiments, the dietary composition may consist essentially of the fatty acid component and the protein component. In other embodiments, the dietary composition may consist of the fatty acid component and the protein component. In other embodiments, the dietary composition may include other components in addition to the fatty acid component and the protein component, as described in greater detail herein.

In various embodiments, the fatty acid component may generally include one or more free fatty acids and/or glycolipids. Free fatty acids may generally be unconjugated fatty acids, whereas glycolipids may be fatty acids conjugated with a carbohydrate. In some embodiments, the fatty acid component may be present in the dietary composition in an amount of at least about 10% by weight of the dietary composition, including, for example, about 30% by weight or about 50% by weight of the dietary composition. In particular embodiments, the fatty acid component may be present in the dietary composition in an amount of about 10% by weight, about 15% by weight, about 20% by weight, about 30% by weight, about 35% by weight, about 40% by weight, about 45% by weight, about 50% by weight, about 55% by weight, about 60% by weight, about 65% by weight, about 70% by weight, about 75% by weight, about 80% by weight, or any value or range between any two of these values. In some embodiments, the fatty acid component may represent about 30% to about 50%, about 30% to about 90%, or about 40% to about 60% by weight of the dietary composition.

In some embodiments, the fatty acid component may have a melting point equal to or greater than about 40° C. In some embodiments, the fatty acid component may have a melting point equal to or less than about 80° C. In some embodiments, the fatty acid component may have a melting point of about 40° C. to about 80° C. In some embodiments, the fatty acid component may have a melting point of about 60° C. to about 80° C. In some embodiments, the fatty acid component may have a melting point of about 63° C. to about 65° C. In particular embodiments, the fatty acid component may have a melting point of about 40° C., about 45° C., about 50° C., about 55° C., about 60° C., about 65° C., about 70° C., about 75° C., about 80° C., or any value or range between any two of these values. The melting point may generally be selected so that it is a temperature that ensures that the fatty acid is inert in the rumen environment.

In various embodiments, the fatty acid component may include at least one saturated fatty acid. For example, the fatty acid component may include 1, 2, 3, 4, 5, 6, or more different saturated fatty acids. In some embodiments, the saturated fatty acid may be present in the fatty acid component in an amount that results in a ruminant consuming the dietary composition to produce a desired quality and quantity of milk, as described in greater detail herein. Thus, in some embodiments, the saturated fatty acid may be present in an amount of at least about 90% by weight of the fatty acid component. In particular embodiments, the saturated fatty acid may be present in an amount of about 90% by weight of the fatty acid component to about 100% by weight of the fatty acid component, including about 90% by weight, about 91% by weight, about 92% by weight, about 93% by weight, about 94% by weight, about 95% by weight, about 96% by weight, about 97% by weight, about 98% by weight, about 99% by weight, about 100% by weight, or any value or range between any two of these values. The saturated fatty acid is not limited by this disclosure, and may include any number of saturated fatty acids now known or later discovered, including all derivatives thereof. For example, derivatives of a saturated fatty acid may include salts, esters, amides, carbonates, carbamates, imides, anhydrides, alcohols, and/or the like.

As used herein, a salt of the fatty acid may be any acid addition salt, including, but not limited to, halogenic acid salts such as, for example, hydrobromic, hydrochloric, hydrofluoric, and hydroiodic acid salts; inorganic acid salts such as, for example, nitric, perchloric, sulfuric, and phosphoric acid salts; organic acid salts such as, for example, sulfonic acid salts (methanesulfonic, trifluoromethane sulfonic, ethanesulfonic, benzenesulfonic, or p-toluenesulfonic), acetic, malic, fumaric, succinic, citric, benzoic, gluconic, lactic, mandelic, mucic, pamoic, pantothenic, oxalic, and maleic acid salts; and amino acid salts such as aspartic or glutamic acid salts. The acid addition salt may be a mono- or di-acid addition salt, such as a di-hydrohalogenic, di-sulfuric, di-phosphoric, or di-organic acid salt. In all cases, the acid addition salt is used as an achiral reagent which is not selected on the basis of any expected or known preference for interaction with or precipitation of a specific optical isomer of the products of this disclosure.

A fatty acid ester, as used herein, means an ester of a fatty acid. For example, the fatty acid ester may be in a form of RCOOR′. R may be any saturated or unsaturated alkyl group including, without limitation, C10, C12, C14, C16, C18, C20, and C24. R′ may be any groups having from about 1 to about 1000 carbon atoms and with or without hetero atoms. In some embodiments, R′ may have from about 1 to about 20, from about 3 to about 10, or from about 5 to about 15 carbon atoms. The hetero atoms may include, without limitation, N, O, S, P, Se, halogen, Si, and B. For example, R′ may be a C₁₋₆alkyl, such as methyl, ethyl or t-butyl; a C₁₋₆alkoxyC₁₋₆alkyl; a heterocyclyl, such as tetrahydrofuranyl; a C₆₋₁₀aryloxyC₁₋₆alkyl, such as benzyloxymethyl (BOM); a silyl, such as trimethylsilyl, t-butyldimethylsilyl and t-butyldiphenylsilyl; a cinnamyl; an allyl; a C₁₋₆alkyl which is mono-, di- or trisubstituted by halogen, silyl, cyano or C₁₋₆aryl, wherein the aryl ring is unsubstituted or substituted by one, two, or three residues selected from the group consisting of C₁₋₇alkyl, C₁₋₇alkoxy, halogen, nitro, cyano and CF₃; or a C₁₋₂alkyl substituted by 9-fluorenyl.

As used herein, a fatty acid amide may generally include amides of fatty acids where the fatty acid is bonded to an amide group. For example, the fatty acid amide may have a formula of RCONR′R″. R may be any saturated or unsaturated alkyl group including, without limitation, C10, C12, C14, C16, C18, C20, and C24. R′ and R″ may each be any group having from about 1 to about 1000 carbon atoms and with or without hetero atoms. In some embodiments, R′ may have from about 1 to about 20, from about 3 to about 10, or from about 5 to about 15 carbon atoms. The hetero atoms may include, without limitation, N, O, S, P, Se, halogen, Si, and B. For example, R′ and R″ each may be an alkyl, an alkenyl, an alkynyl, an aryl, an aralkyl, a cycloalkyl, a halogenated alkyl, or a heterocycloalkyl group.

A fatty acid anhydride may generally refer to a compound which results from the condensation of a fatty acid with a carboxylic acid. Illustrative examples of carboxylic acids that may be used to form a fatty acid anhydride include acetic acid, propionic acid, benzoic acid, and the like.

An alcohol of a fatty acid refers to a fatty acid having straight or branched, saturated, radical groups with 3-30 carbon atoms and one or more hydroxy groups. The alkyl portion of the alcohol component can be propyl, butyl, pentyl, hexyl, iso-propyl, iso-butyl, sec-butyl, tert-butyl, or the like. One of skill in the art may appreciate that other alcohol groups may also be useful in the present disclosure.

In some embodiments, the saturated fatty acid may include a palmitic acid compound. The palmitic acid compound is not limited by this disclosure, and may include one or more of a conjugated palmitic acid, unconjugated palmitic acid, free palmitic acid, palmitic acid derivatives, and/or the like. Palmitic acid, also known as hexadecanoic acid, has a molecular formula of CH₃(CH₂)₁₄CO₂H. Specific examples of palmitic acid derivatives may include palmitic acid esters, palmitic acid amides, palmitic acid salts, palmitic acid carbonates, palmitic acid carbamates, palmitic acid imides, palmitic acid anhydrides, and/or the like. The palmitic acid compound may be present in the fatty acid component in an amount of at least about 60% by weight of the fatty acid component, such as, for example, about 60% by weight of the fatty acid to about 100% by weight of the fatty acid, including about 60% by weight, about 65% by weight, about 70% by weight, about 75% by weight, about 80% by weight, about 85% by weight, about 90% by weight, about 95% by weight, about 98% by weight, about 99% by weight, about 100% by weight, or any value or range between any two of these values. In some embodiments, the fatty acid component may consist essentially of the palmitic acid compound. In other embodiments, the fatty acid component may consist of or be entirely composed of the palmitic acid compound.

In some embodiments, the saturated fatty acid may include a stearic acid compound. The stearic acid compound is not limited by this disclosure, and may include conjugated stearic acid, unconjugated stearic acid, free stearic acid, stearic acid derivatives, and/or the like. Stearic acid, also known as octadecanoic acid, has a chemical formula of CH₃(CH₂)₁₆CO₂H. Specific examples of stearic acid derivatives may include stearic acid esters, stearic acid amides, stearic acid salts, stearic acid carbonates, stearic acid carbamates, stearic acid imides, stearic acid anhydrides, and/or the like. Because stearic acid in large amounts may hinder milk production capacity of the mammary gland, the amount of stearic acid may be present in the fatty acid component in an amount of about 30% or less by weight of the fatty acid component. In particular embodiments, the stearic acid compound may include about 30% by weight of the fatty acid component, about 25% by weight of the fatty acid component, about 20% by weight of the fatty acid component, about 15% by weight of the fatty acid component, about 10% by weight of the fatty acid component, about 5% by weight of the fatty acid component, or any value or range between any two of these values.

In some embodiments, the fatty acid component may include an unsaturated fatty acid. Unsaturated fatty acid, as used herein, refers to any mono- or polyunsaturated fat, and includes unsaturated trans fatty acids. The unsaturated fatty acids must contain at least one alkene bond and may contain two or more alkene groups in any position in the hydrocarbon chain, and the unsaturation may or may not be present as a conjugated system of double bonds. The unsaturated fatty acid is not limited by this disclosure, and may include any number of unsaturated fatty acids now known or later discovered, including all derivatives thereof. For example, derivatives of an unsaturated fatty acid may include salts, esters, amides, anhydrides, alcohols, and/or the like, as previously described herein. In various embodiments, an amount of unsaturated fatty acid may be used in the fatty acid component to affect a desired quality of milk produced by the ruminant consuming the dietary composition, as described in greater detail herein. Thus, in some embodiments, the fatty acid component may be substantially free of unsaturated fatty acids. As used herein with respect to unsaturated fatty acids, the term “substantially free” is understood to mean substantially no amount of unsaturated fatty acids or about 10% or less by weight of unsaturated fatty acids, including trace amounts of unsaturated fatty acids. Accordingly, the unsaturated fatty acid may be present in the fatty acid component in an amount of about 10% or less by weight of the fatty acid component, including about 10% or less by weight, about 5% or less by weight, about 4% or less by weight, about 3% or less by weight, about 2% or less by weight, about 1% or less by weight, about 0.5% or less by weight, about 0% by weight, or any value or range between any two of these values.

In various embodiments, at least a portion of the fatty acid component may be contained. In some embodiments, the fatty acid component may be pre-contained prior to providing 105 the fatty acid component. In other embodiments, the fatty acid component may be contained as a result of the various processes 105, 110, 115, 120, 125 described herein. In some embodiments, the fatty acid may generally be contained by at least one supermolecular structure. Supermolecular structures may include vesicular structures such as microemulsions, liposomes (vesicles), micelles, and reverse micelles. The liposomes (vesicles) may contain an aqueous volume that is entirely enclosed by a membrane composed of lipid molecules, such as phospholipids. In some embodiments, the liposomes may have a bilayer membrane. In some embodiments, the liposomes may include at least one surfactant. Examples of surfactants may include polyoxyethylene ethers and esters of fatty acids. The surfactant may have an hydrophilic-lipophilic balance (HLB) value of about 2 to about 12, including about 2, about 3, about 4, about 5, about 6, about 7, about 8, about 9, about 10, about 11, about 12, or any range or value between any two of these values. Micelles and reverse micelles are microscopic vesicles that contain amphipathic constituents but do not contain an aqueous volume that is entirely enclosed by a membrane. In micelles, the hydrophilic part of the amphipathic compound is on the outside (on the surface of the vesicle). In reverse micelles, the hydrophobic part of the amphipathic compound is on the outside. The reverse micelles may thus contain a polar core that can solubilize both water and macromolecules within the inverse micelle. As the volume of the core aqueous pool increases, the aqueous environment may begin to match the physical and chemical characteristics of bulk water. The resulting inverse micelle may be referred to as a microemulsion of water in oil.

In some embodiments, at least a portion of the fatty acid component may be contained in a core of a micelle or a vesicle. The core may include any number of particles therein in addition to the fatty acid. The core composition may be made of a core material that includes at least one of a protein material, a cellulosic material, an amino acid, and an amino acid derivative. In some embodiments, the protein material may be obtained from the protein component.

In various embodiments, at least a portion of the fatty acid component may be encapsulated. In some embodiments, the fatty acid component may be pre-encapsulated prior to providing 105 the fatty acid component. In other embodiments, the fatty acid component may be encapsulated as a result of the various processes 105, 110, 115, 120, 125 described herein. In some embodiments, the fatty acid component may generally be encapsulated by a capsule. The capsule may include a capsule shell, which is made up of at least one polysaccharide or protein. Illustrative examples of capsule shells as described herein may include capsule shells including agar, gelatin, starch casein, chitosan, soya bean protein, safflower protein, alginates, gellan gum, carrageenan, xanthan gum, phthalated gelatin, succinated gelatin, cellulosephthalate-acetate, polyvinylacetate, hydroxypropyl methylcellulose, polyvinylacetate-phthalate, polymerisates of acrylic esters, polymerisates of methacrylic esters, and/or any mixture thereof. In some embodiments, the protein for the capsule shell may be obtained from the protein component described herein.

The protein component may contain any type of protein or combination of proteins, and is not limited by this disclosure. In some embodiments, the protein component may generally contain a protein that is suitable for animal feeds and supplements. In some embodiments, the protein component may include an oilseed meal. Oilseed meal is generally derived from residue that remains after reserved oil is removed from oilseeds. The oilseed meal may be rich in protein and variable in residual fats and oils. Illustrative examples of oilseed meal include soy meal, bean meal, rapeseed meal, soybean meal, sunflower meal, coconut meal, olive meal, linseed meal, grapeseed meal, cottonseed meal, camelina meal, mustard seed meal, crambe seed meal, safflower meal, rice meal, peanut meal, corn gluten meal, corn gluten feed, distillers dried grains, distillers dried grains with solubles, wheat gluten, and/or the like.

In various embodiments, one or more other ingredients may be added 115 to the mixture. The other ingredients may be added 115 at substantially the same time as processes 105 and 110, may be added subsequent to processes 105 and 110, may be added prior to processes 105 and 110, or may be added during process 120 and 125, as described in greater detail herein. Illustrative examples of other ingredients that may be added 115 include an emulsifier, a glucogenic precursor, an antioxidant, a vitamin, carnitine, an amino acid, a mineral, a carbohydrate, a binding agent, a bulking agent, a filler, water, and the like, or a combination thereof. Any number and combination of ingredients may be added 115 to the mixture. The other ingredients may generally be added 115 in various amounts necessary to provide beneficial nutritional and dietary needs of the ruminant that is to consume the dietary composition. For example, other ingredients may include an amino acid and a mineral, each in an amount sufficient to provide beneficial nutritional and dietary needs of the ruminant.

The glucogenic precursor may include at least one of glycerol, propylene glycol, molasses, propionate, glycerine, propane diol, calcium propionate, propionic acid, octanoic acid, steam-exploded sawdust, steam-exploded wood chips, steam-exploded wheat straw, algae, algae meal, microalgae, and/or the like. The glucogenic precursor may generally be included in the dietary composition to provide an energy source to the ruminant so as to prevent gluconeogenesis from occurring within the ruminant's body.

The antioxidant is not limited by this disclosure and may include any antioxidants or combination of antioxidants, particularly those used in animal feed and dietary compositions. Illustrative examples of antioxidants may include alpha-carotene, beta-carotene, ethoxyquin, butylated hydroxyanisole (BHA), butylated hydroxytoluene (BHT), cryptoxanthin, lutein, lycopene, zeaxanthin, vitamin A, vitamin C, vitamin E, selenium, alpha-lipoic acid, and/or the like.

The vitamin may include any combination of vitamins including, without limitation, vitamin A, vitamin B, vitamin C, vitamin D, vitamin E, vitamin K, and/or the like. The vitamin may include any vitamins from each particular vitamer group, including A vitamins, B vitamins, C vitamins, D vitamins, E vitamins, K vitamins, and/or the like. Specific examples of B vitamins include thiamine (vitamin B₁), riboflavin (vitamin B₂), niacin (vitamin B₃), pantothenic acid (vitamin B₅), pyridoxine (vitamin B₆), biotin (vitamin B₇), folic acid (vitamin B₉), cobalamin (vitamin B₁₂), and choline (vitamin Bₚ).

One additional ingredient that may be added 115 is carnitine. Carnitine may be included in the dietary composition to aid in the breakdown of fatty acids to generate metabolic energy in the ruminant. In some embodiments, carnitine may be provided as a portion of a carnitine premix composition.

In some embodiments, the amino acid may be an essential amino acid, including any combination of leucine, lysine, histidine, valine, arginine, threonine, isoleucine, phenylalanine, methionine, tryptophan, and/or any derivative thereof. In some embodiments, the amino acid may be a non-essential amino acid, including any combination of alanine, asparagine, aspartate, cysteine, glutamate, glutamine, glycine, proline, serine, tyrosine, and/or any derivative thereof. The amino acid and/or any derivative thereof may also include amino acids and derivatives of both non-essential and essential amino acids. The amino acid may generally be included in the dietary composition to provide a nutritional aid in various physiological processes in the ruminant, such as, for example, increasing muscle mass, providing energy, aiding in recovery, and/or the like. In some embodiments, the amino acid may be obtained from an amino acid premix composition.

The mineral may be any mineral that is a generally recognized as safe (GRAS) mineral or a combination of such minerals. The mineral may further be obtained from any mineral source that provides a bioavailable mineral. In some embodiments, the mineral may be one or more of calcium, sodium, magnesium, potassium, phosphorous, zinc, selenium, manganese, iron, cobalt, copper, iodine, molybdenum, and/or the like. In some embodiments, the mineral may be selected from one or more of a sodium salt, a calcium salt, a magnesium salt, a cobalt salt, a manganese salt, a potassium salt, an iron salt, a zinc salt, copper sulfate, copper oxide, selenium yeast, a chelated mineral, and/or the like. Illustrative examples of sodium salts include monosodium phosphate, sodium acetate, sodium chloride, sodium bicarbonate, disodium phosphate, sodium iodate, sodium iodide, sodium tripolyphosphate, sodium sulfate, sodium selenite, and/or the like. Illustrative examples of calcium salts include calcium acetate, calcium carbonate, calcium chloride, calcium gluconate, calcium hydroxide, calcium iodate, calcium iodobehenate, calcium oxide, anhydrous calcium sulfate, calcium sulfate dehydrate, dicalcium phosphate, monocalcium phosphate, tricalcium phosphate, and/or the like. Illustrative magnesium salts include magnesium acetate, magnesium carbonate, magnesium oxide, magnesium sulfate, and/or the like. Illustrative cobalt salts include cobalt acetate, cobalt carbonate, cobalt chloride, cobalt oxide, cobalt sulfate, and/or the like. Illustrative examples of manganese salts include manganese carbonate, manganese chloride, manganese citrate, manganese gluconate, manganese orthophosphate, manganese oxide, manganese phosphate, manganese sulfate, and/or the like. Illustrative examples of potassium salts include potassium acetate, potassium bicarbonate, potassium carbonate, potassium chloride, potassium iodate, potassium iodide, potassium sulfate, and/or the like. Illustrative examples of iron salts include iron ammonium citrate, iron carbonate, iron chloride, iron gluconate, iron oxide, iron phosphate, iron pyrophosphate, iron sulfate, reduced iron, and/or the like. Illustrative examples of zinc salts include zinc acetate, zinc carbonate, zinc chloride, zinc oxide, zinc sulfate, and/or the like.

The carbohydrate is not limited by this disclosure and may include any carbohydrates or combination of carbohydrates, particularly those used in animal feed and dietary compositions. In some embodiments, the carbohydrate may generally provide a source of energy for the dietary composition. Illustrative examples of carbohydrates may include molasses, sugar beet pulp, sugar cane, wheat bran, wheat middlings, wheat mill run, oat hulls, grain hulls, soya hulls, soybean hulls, peanut hulls, wood, brewery byproducts, beverage industry byproducts, forages, roughages, grass meal, hay meal, hay, alfalfa meal, alfalfa, straw, silages, sugars, starches, cellulose, hemicellulose, wheat, corn, oats, sorghum, millet, barley, barley fiber, barley hulls, barley middlings, barley bran, malting barley screenings, malting barley and fines, malt rootlets, maize bran, maize middlings, maize cobs, maize screenings, maize fiber, millet, rice, rice bran, rice middlings, rye, triticale, brewers grain, coffee grinds, tea leaf fines, citrus fruit pulp, rind residues, algae, algae meal, microalgae, and/or the like.

The carbohydrate may be obtained from any carbohydrate source, and thus the source is not limited by this disclosure. In some embodiments, the carbohydrate may be obtained by breaking down a complex sugar source. Illustrative carbohydrate sources may include sugar, starch, cellulose, hemicellulose, and/or the like. In some embodiments, the carbohydrate may be obtained from various crops that contain carbohydrates. Illustrative crops may include wheat, corn, oats, sorghum, millet, barley, and/or the like.

The binding agent may provide adhesive properties to the dietary composition, particularly so that the dietary composition does not fall apart in various forms such as pellet and tablet forms. Examples of binding agents include polysaccharides, proteins, and the like, or a combination thereof. The bulking agent may generally increase the bulk of the dietary composition without affecting the taste of the dietary composition. Examples of bulking agents may include silicate, kaolin, clay, and/or the like. The filler may generally be used to increase bulk, weight, viscosity, opacity, strength, and/or the like. Examples of filler may include gluten feed, sunflower hulls, distillers grains, guar hulls, wheat middlings, rice hulls, rice bran, oilseed meals, dried blood meal, animal byproduct meal, fish byproduct meal, dried fish solubles, feather meal, poultry byproducts, meat meal, bone meal, dried whey, soy protein concentrate, soy flour, yeast, wheat, oats, grain sorghum, corn feed meal, algae meal, rye, corn, barley, aspirated grain fractions, brewers dried grains, corn flower, corn gluten meal, feeding oat meal, sorghum grain flour, wheat mill run, wheat red dog, hominy feed, wheat flower, wheat bran, wheat germ meal, oat groats, rye middlings, cotyledon fiber, and/or ground grains.

In various embodiments, water may be present in the dietary composition. In some embodiments, the water may be inherently present in any of the ingredients in the dietary composition. In some embodiments, as previously described herein, an amount of water may be added 115. The water may be included in an amount that is separate from any amounts of water that may be inherently present in any of the other ingredients described herein. The water may be present in the dietary composition in an amount that is about 3% or less by weight, including about 0.5% by weight, about 1% by weight, about 2% by weight, about 3% by weight, or any value or range between any two of these values. In some embodiments, the amount of water may be added 115 to control a total moisture content of the dietary composition. An illustrative moisture content may be from about 5% to about 25% or from about 10% to about 15% by weight of the dietary composition, including about 5%, about 10%, about 15%, about 20%, about 25%, or any value or range between any two of these values (including endpoints). In one embodiment, the moisture content may be about 12% by weight of the dietary composition.

In some embodiments, at least one cellulosic material may also be added 115. The cellulosic material may generally provide a source of fiber for the ruminant to lower cholesterol levels and promote proper digestive function. Illustrative examples of cellulosic materials include wheat bran, wheat middlings, wheat mill run, oat hulls, oat bran, soya hulls, grass meal, hay meal, alfalfa meal, alfalfa, straw, hay, algae, algae meal, microalgae, and/or the like.

In some embodiments, a micronutrient mixture may be added 115. Micronutrient mixtures are not limited by this disclosure and may generally contain any micronutrient mixture now known or later developed. The micronutrient mixture may include various components, such as at least one vitamin and at least one mineral, as described in greater detail herein. In some embodiments, the micronutrient mixture may be present in a micronutrient premix composition.

In various embodiments, the dietary composition may be processed 120. In some embodiments, processing 120 may be completed prior to processes 105, 110, 115 to prepare various portions of the dietary composition for mixing and/or the like. In other embodiments, processing 120 may be completed after processes 105, 110, 115 to prepare a final product. In some embodiments, processing 120 may include forming the dietary composition into a capsule, a shell, a pellet, a tablet, a granular material, and/or the like. Processing 120 may include pressing, molding, extruding, grinding, pelleting, encapsulating, granulating and/or the like. Pressing may include, for example, applying a pressure to an amount of the dietary composition. Molding may include, for example, open molding, compression molding, injection molding, centrifugal molding, or the like. Extruding may include, for example, forming an amount of the dietary composition by forcing the dietary composition through a die having a desired shape and size.

Grinding may be performed by various grinding devices known to those having ordinary skill in the art, such as a hammer mill, a roller mill, a disk mill, or the like. The dietary composition and/or portions thereof such as the protein component may be ground to various sizes, such as particle size (for instance, measured in millimeters), mesh sizes, surface areas, or the like. According to some embodiments, the dietary composition and/or portions thereof may be ground to an average particle size of about 0.05 mm to about 10 mm. More particularly, the dietary composition may be ground to produce a granular material having an average particle size of about 0.05 mm, about 0.1 mm, about 0.2 mm, about 0.5 mm, about 1 mm, about 2 mm, about 3 mm, about 4 mm, about 5 mm, about 6 mm, about 7 mm, about 8 mm, about 9 mm, about 10 mm, or any value or range between any two of these values. In some embodiments, the dietary composition may be ground so that about 20% to 50% of the ground dietary composition is retained by a mesh having openings with a size of about 10 mm and so that about 70% to about 90% of the ground dietary composition is retained by a mesh having openings with a size of about 1 mm. In some embodiments, the dietary compositions and/or various portions thereof may have a varying distribution of particle sizes based upon the ingredients. For example, in embodiments containing one or more wheat ingredients, the particle size may be distributed so that about 95% of the ground wheat ingredients are retained by a mesh having openings with a size of about 0.0625 mm and so that about 65% of the ground wheat ingredients are retained by a mesh having openings with a size of about 1.0 mm. In another example, such as embodiments containing one or more barley ingredients, the particle size may be distributed so that about 95% of the ground barley ingredients are retained by a mesh having openings with a size of about 0.0625 mm and so that about 60% of the ground barley ingredients are retained by a mesh having openings with a size of about 1.0 mm. The varying mesh sizes of each ingredient may be independent of mesh sizes for other ingredients.

Grinding may provide various benefits, such as improving certain characteristics of the protein component and/or the dietary composition formed therefrom. For instance, even and fine particle size may improve the mixing of different ingredients. According to certain embodiments, grinding may be configured to decrease a particle size of certain components of the dietary composition, for example, to increase the surface area open for enzymes in the gastrointestinal tract, which may improve the digestibility of nutrients, and/or to increase the palatability of the feed.

In some embodiments, the granular material or powder may be used in subsequent processes such as molding, extrusion, and/or tableting. In some embodiments, processing 120 may include drying the dietary composition and/or portions thereof. Drying may generally be completed to remove any excess water or other undesired materials, as well as to provide a material that is suitable for encapsulation, pelleting, extrusion, grinding, pressing, and/or the like. In some embodiments, drying may be completed to ensure a desired moisture content of the dietary composition. Illustrative moisture contents may include about 12% by weight of the dietary composition.

Granular material, as used herein, refers to a conglomeration of discrete solid, macroscopic particles and is meant to encompass a wide variety of material types, shapes, and sizes. Granular material includes powders as a subset, but also includes groups of larger particles. Granular material may be particularly well-suited for tableting and encapsulation, as well as molding.

In various embodiments, additional steps may be completed 125. The additional steps are not limited by this disclosure, and may include any additional steps necessary to prepare a dietary composition. An illustrative additional step may be to disperse the fatty acid composition in water. In some embodiments, dispersing the fatty acid composition in water may be completed so that the fatty acid composition and the protein composition can be adequately combined. Dispersing the fatty acid composition may include any amount of fatty acid and any amount of water sufficient to obtain an emulsion or a liquid suspension. For example, the fatty acid composition may include the fatty acid component and water in a volume/volume ratio from about 1:20 to about 1:1, from about 1:15 to about 2:1, from about 1:10 to about 3:1, or any value or range between any two of these values (including endpoints).

Another illustrative additional step that may be completed 125 may be to heat the fatty acid compound. In some embodiments, heating the fatty acid composition may be completed so that the fatty acid composition and the protein composition can be adequately combined. The fatty acid composition may generally be heated to a temperature at which the fatty acid composition melts to a semisolid or a liquid form. One illustrative temperature may be equal to or greater than about 40° C. Another illustrative temperature may be equal to or less than about 80° C. Another illustrative temperature may be about 40° C. to about 80° C. Other illustrative temperatures may include about 40° C., about 45° C., about 50° C., about 55° C., about 60° C., about 65° C., about 70° C., about 75° C., about 80° C., or any value or range between any two of these values.

In various embodiments, a method of increasing milk fat content in ruminants may include providing at least the dietary composition as described herein to the ruminant for ingestion. In some embodiments, the dietary composition may be mixed with feed and then provided to the ruminant. In particular embodiments, the dietary composition may be mixed with feed by an end user, such as a dairy farmer and/or the like. Thus, the end user may receive the dietary composition from a manufacturer, a distributor, and/or the like, may mix the dietary composition with the feed, and may provide the mixture to the ruminant. In other embodiments, the dietary composition may be directly fed to a ruminant without mixing with a feed.

In various embodiments, the dietary composition may be mixed with a feed in an amount such that the dietary composition is present in a premix/feed mixture in any ratio, including, for example, a ratio of about 1:25 dietary composition to feed to about 1:75 dietary composition to feed. Other illustrative ratios of dietary composition to feed may include 1:25, 1:30, 1:35, 1:40, 1:45, 1:50, 1:55, 1:60, 1:65, 1:70, 1:75, or any value or range between any two of these values (including endpoints). In some embodiments, the ratio may be dependent upon a concentration of the fatty acid component and/or the carbohydrate component in the dietary composition. Thus, for example, if the fatty acid component or the carbohydrate component is a higher concentration in the dietary composition, a higher ratio of dietary composition to feed may be used such that less dietary composition and more feed are used.

In various embodiments, the dietary composition may be provided to the ruminant in an amount such that the ruminant receives at least about 10 grams of fatty acid per kilogram of milk produced by the ruminant each day. The amount may be based on the previous day's milk production by the ruminant, an average day based on the previous week's milk production by the ruminant, an average day based on the previous month's milk production by the ruminant, an average production of milk by the ruminant when not provided the dietary composition, and/or the like. In some embodiments, the ruminant may be provided with about 0.5 kg to about 4 kg of the dietary composition each day per 30 kg of weight of the ruminant, including about 0.5 kg, about 0.75 kg, about 1 kg, about 1.5 kg, about 2 kg, about 2.5 kg, about 3 kg, about 3.5 kg, about 4 kg, or any value or range between any two of these values (including endpoints). In some embodiments, the ruminant may be provided with additional amounts of the dietary composition to make up for portions of the dietary composition that are not consumed by the ruminant, such as amounts that are spilled by the ruminant when consuming the dietary composition, amounts that are consumed by other animals, and/or the like.

In some embodiments, providing the dietary composition to the ruminant for the ruminant to consume may result in an increase in production of milk and/or an increase in fat content of the milk produced. These increases may generally be relative to a similar ruminant that does not receive the dietary composition, an average of similar ruminants not receiving the dietary composition, an average of the milk production quantity and fat content of the same ruminant when not provided the dietary composition, and/or the like. In particular embodiments, the milk production may increase by an amount of about 1% to about 10%, including about 1%, about 2%, about 3%, about 4%, about 5%, about 6%, about 7%, about 8%, about 9%, about 10%, or any value or range between any two of these values. In particular embodiments, the milk fat content may increase by an amount of about 10% to about 15%, including about 10%, about 11%, about 12%, about 13%, about 14%, about 15%, or any value or range between any two of these values.

### EXAMPLES

### Example 1

### Making a “Premix” Composition

A dietary composition to be used as a premix composition added to ruminant feed is made using a process of combining a fatty acid component and a protein component. Prior to combining with the protein component, the fatty acid component is mixed with water such that a water-fatty acid mixture contains 10% water and 90% fatty acid to form a liquid suspension. Such a liquid suspension will ensure that the fatty acid can be adequately mixed with the protein component.

The fatty acid component is in an amount that is about 50% by weight of the dietary composition. The fatty acid component includes about 90% by weight of a palmitic acid composition, about 10% by weight of a stearic acid composition, and no unsaturated trans fatty acids. The dietary composition also includes 50% by weight of a protein component to include additional nutrients not currently present and/or lacking in the ruminant's current feed. The protein component includes oilseed meal selected from grapeseed meal and peanut meal.

The resulting premix composition is packaged into bulk shipping containers that can be stored and/or shipped to distributors. The distributors will divide the bulk amounts into suitable amounts that are sold to end users such as dairy farmers and/or the like. Once the end user receives the premix composition, he/she may store and/or mix the premix composition with the ruminant feed prior to feeding the ruminant.

### Example 2

### Feeding a Dairy Cow

A premix-feed mixture is made by mixing 1.5 kg of a premix dietary composition as described above with respect to Example 1 with 45 kg of TMR for a cow to consume each day. Thus, the premix-feed mixture is a ratio of premix dietary composition to feed in an amount of about 1:30. This amount of dietary composition is selected to ensure that a dairy cow weighing about 635 kg will consume about 2 kg of the premix per 30 kg of her weight. This amount corresponds to about 10 grams of free palmitic acid for every kilogram of milk that she produces that day.

The cow has a normal (untreated) average daily production of 30 kg milk. The cow is provided with the premix-feed mixture described above to increase the milk fat and the quantity of the milk produced. The cow is fed this mixture for 30 days. At the end of the 30 day period, she is producing 10% more milk than she did previously, and the milk that she produces contains 10% more milk fat content than the milk she produced previously.

### Example 3

### Providing to a Large Group of Cows

The protein premix composition as described above with respect to Example 1 is mixed with a daily TMR and provided to a large group of cows on a commercial dairy farm to confirm its effectiveness. A group of 300 dairy cows from the commercial dairy farm are selected at random to provide a wide variety of variation in various characteristics, such as breed, weight, age of the cow, and the like. The 300 cows are divided into two groups: a sample cow group of 150 cows and a control cow group of 150 cows. Each day, the sample cow group is fed, ad libitum, a standard TMR feed with the dietary composition mixed therein. The control cow group is fed the standard TMR feed given to the sample group of cows ad libitum, but without the dietary composition. The 300 cows are monitored for the amount of feed and/or booster consumed, changes in weight, an amount of milk the cow produces each day, and the composition of the milk produced by the cow each day. Monitoring continues for a period of 30 days. A comparison of the two groups of cows over this period of time shows a statistically significant improvement for the group that consumed the protein premix composition over the control group that did not receive the protein premix composition.

### Example 4

### Two-Month Study of Efficacy of Premix Dietary Composition

An experiment is performed where conventional complete feed is replaced with a feed that is supplemented with a premix dietary composition according to the present disclosure. The experiment is continued for two months. The premix dietary composition includes the following ingredients and amounts (in percent by total weight of the premix dietary composition).

| | |
|---|---|
| Palmitic Acid | 50 |
| Stearic Acid | 5 |
| Soy meal | 10 |
| Sunflower meal | 10 |
| Peanut meal | 10 |
| Rapeseed meal | 10 |
| Water | 5 |

The protein component includes the soy meal, the sunflower meal, the peanut meal, and the rapeseed meal. The ingredients described above are mixed together, and upon reaching an end user, are mixed with the cow's daily feed. Upon feeding the premix/daily feed mixture to a cow, the following results are obtained from the milk produced by the cow. “Reference” refers to milk obtained from the same cow that is only fed the daily feed without the “premix” combination.

| | Reference | Test Feed |
|---|---|---|
| Milk (kg/d) | 29.5 | 32.5 |
| Fat % by weight | 3.98 | 4.43 |

As shown in the expected results above, milk fat concentrations and the amount of milk produced increase significantly when the cow consumes the test feed according to the present disclosure.

### Example 5

### Fatty Acid Composition

The following table describes a fatty acid composition that is used to increase the volume of milk produced by a ruminant and the milk fat content of the milk produced by the ruminant.

| Fatty Acid | % of Fatty Acid Component (by weight) |
|---|---|
| Palmitic Acid | ≧90 |
| Stearic Acid | ≦10 |
| Unsaturated Trans-fatty Acid | 0 |

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases at least one and one or more to introduce claim recitations. However, the use of such phrases should not be construed to imply that the introduction of a claim recitation by the indefinite articles “a” or an limits any particular claim containing such introduced claim recitation to embodiments containing only one such recitation, even when the same claim includes the introductory phrases one or more or at least one and indefinite articles such as “a” or an (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera As a non-limiting example, each range discussed herein can be readily broken down into a lower third, middle third and upper third, et cetera As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed is:

1. A premix dietary composition comprising:
a fatty acid component, wherein the fatty acid component comprises at least about 90% saturated fatty acid by weight; and
a protein component,
wherein the fatty acid component is present in the dietary composition in an amount of at least about 10% by weight of the dietary composition.

2. The premix dietary composition of claim 1, wherein the premix dietary composition consists essentially of the fatty acid component and the protein component.

3. The premix dietary composition of claim 1, wherein the premix dietary composition consists of the fatty acid component and the protein component.

4. The premix dietary composition of claim 1, wherein the protein component comprises an oilseed meal.

5. The premix dietary composition of claim 4, wherein the oilseed meal is selected from at least one of soy meal, bean meal, rapeseed meal, sunflower meal, coconut meal, olive meal, linseed meal, grapeseed meal, cottonseed meal, camelina meal, mustard seed meal, crambe seed meal, safflower meal, rice meal, or peanut meal.

6. The premix dietary composition of claim 1, wherein the premix dietary composition further comprises a moisture content of about 12% by weight of the premix dietary composition.

7. The premix dietary composition of claim 1, wherein the premix dietary composition further comprises a moisture content of about 5% to about 25% by weight of the premix dietary composition.

8. The premix dietary composition of claim 1, wherein the premix dietary composition further comprises a moisture content of about 10% to about 15% by weight of the premix dietary composition.

9. The premix dietary composition of claim 1, wherein the fatty acid component is present in the dietary composition in an amount of at least about 30% by weight of the dietary composition.

10. The premix dietary composition of claim 1, wherein the fatty acid component is present in the dietary composition in an amount of at least about 50% by weight of the dietary composition.

11. The premix dietary composition of claim 1, wherein the fatty acid component comprises a palmitic acid compound.

12. The premix dietary composition of claim 11, wherein the palmitic acid compound comprises free palmitic acid.

13. The premix dietary composition of claim 11, wherein the palmitic acid compound comprises a palmitic acid derivative selected from a palmitic acid ester, a palmitic acid amide, a palmitic acid salt, a palmitic acid carbonate, a palmitic acid carbamates, a palmitic acid imide, a palmitic acid anhydride, and a combination thereof.

14. The premix dietary composition of claim 1, wherein the fatty acid component comprises a palmitic acid compound in an amount of at least about 60% by weight of the fatty acid component.

15. The premix dietary composition of claim 1, wherein the fatty acid component comprises a palmitic acid compound in an amount of at least about 80% by weight of the fatty acid component.

16. The premix dietary composition of claim 1, wherein the fatty acid component comprises a palmitic acid compound in an amount of at least about 90% by weight of the fatty acid component.

17. The premix dietary composition of claim 1, wherein the fatty acid component comprises an unsaturated trans fatty acid in an amount of about 5% or less by weight of the fatty acid component.

18. The premix dietary composition of claim 1, wherein the fatty acid component comprises an unsaturated trans fatty acid in an amount of about 4% or less by weight of the fatty acid component.

19. The premix dietary composition of claim 1, wherein the fatty acid component comprises an unsaturated trans fatty acid in an amount of about 3% or less by weight of the fatty acid component.

20. The premix dietary composition of claim 1, wherein the fatty acid component comprises an unsaturated trans fatty acid in an amount of about 2% or less by weight of the fatty acid component.

21. The premix dietary composition of claim 1, wherein the fatty acid component comprises an unsaturated trans fatty acid in an amount of about 1% or less by weight of the fatty acid component.

22. The premix dietary composition of claim 1, wherein the fatty acid component comprises an unsaturated trans fatty acid in an amount of about 0.5% or less by weight of the fatty acid component.

23. The premix dietary composition of claim 1, wherein the fatty acid component is substantially free of unsaturated trans fatty acids.

24. The premix dietary composition of claim 1, wherein the saturated fatty acid is present in the fatty acid component in an amount of at least about 95% by weight of the fatty acid component.

25. The premix dietary composition of claim 1, wherein the saturated fatty acid is present in the fatty acid component in an amount of at least about 98% by weight of the fatty acid component.

26. The premix dietary composition of claim 1, wherein the fatty acid component has a melting point of about 60° C. to about 80° C.

27. The premix dietary composition of claim 1, wherein the fatty acid component has a melting point of about 63° C. to about 65° C.

28. The premix dietary composition of claim 1, wherein the fatty acid component has a melting point equal to or greater than about 40° C.

29. The premix dietary composition of claim 1, wherein the fatty acid component comprises stearic acid in an amount of about 30% or less by weight of the fatty acid component.

30. The dietary composition of claim 1, further comprising at least one glucogenic precursor comprising glycerol, propylene glycol, molasses, propionate, glycerine, propane diol, calcium propionate, or a combination thereof.

31. The premix dietary composition of claim 1, further comprising at least one vitamin comprising vitamin A, vitamin B, vitamin C, vitamin D, vitamin E, vitamin K, or a combination thereof.

32. The premix dietary composition of claim 1, further comprising at least one vitamin comprising at least one B vitamin selected from thiamine, riboflavin, niacin, pantothenic acid, pyridoxine, biotin, folic acid, cobalamin, choline, and a combination thereof.

33. The premix dietary composition of claim 1, further comprising carnitine.

34. The premix dietary composition of claim 1, further comprising urea.

35. The premix dietary composition of claim 1, further comprising at least one amino acid comprising leucine, lysine, histidine, valine, arginine, threonine, isoleucine, phenylalanine, methionine, tryptophan, any derivative thereof, or any combination thereof.

36. The premix dietary composition of claim 1, further comprising at least one mineral comprising at least one ion of calcium, sodium, magnesium, potassium, phosphorus, zinc, selenium, manganese, iron, cobalt, copper, iodine, molybdenum, or a combination thereof.

37. The premix dietary composition of claim 1, further comprising at least one mineral comprising at least one sodium salt selected from monosodium phosphate, sodium acetate, sodium chloride, sodium bicarbonate, disodium phosphate, sodium iodate, sodium iodide, sodium tripolyphosphate, sodium sulfate, sodium selenite, and a combination thereof.

38. The premix dietary composition of claim 1, further comprising at least one mineral comprising at least one calcium salt selected from calcium acetate, calcium carbonate, calcium chloride, calcium gluconate, calcium hydroxide, calcium iodate, calcium iodobehenate, calcium oxide, anhydrous calcium sulfate, calcium sulfate dehydrate, dicalcium phosphate, monocalcium phosphate, tricalcium phosphate, and a combination thereof.

39. The premix dietary composition of claim 1, further comprising at least one mineral comprising at least one magnesium salt selected from magnesium acetate, magnesium carbonate, magnesium oxide, magnesium sulfate, and a combination thereof.

40. The premix dietary composition of claim 1, further comprising at least one mineral comprising at least one cobalt salt selected from cobalt acetate, cobalt carbonate, cobalt chloride, cobalt oxide, cobalt sulfate, and a combination thereof.

41. The premix dietary composition of claim 1, further comprising at least one mineral comprising at least one manganese salt selected from manganese carbonate, manganese chloride, manganese citrate, manganese gluconate, manganese orthophosphate, manganese oxide, manganese phosphate, manganese sulfate, and a combination thereof.

42. The premix dietary composition of claim 1, further comprising at least one mineral comprising at least one potassium salt selected from potassium acetate, potassium bicarbonate, potassium carbonate, potassium chloride, potassium iodate, potassium iodide, potassium sulfate, and a combination thereof.

43. The premix dietary composition of claim 1, further comprising at least one mineral comprising at least one iron salt selected from iron ammonium citrate, iron carbonate, iron chloride, iron gluconate, iron oxide, iron phosphate, iron pyrophosphate, iron sulfate, reduced iron, and a combination thereof.

44. The premix dietary composition of claim 1, further comprising at least one mineral comprising at least one zinc salt selected from zinc acetate, zinc carbonate, zinc chloride, zinc oxide, zinc sulfate, and a combination thereof.

45. The premix dietary composition of claim 1, further comprising at least one mineral comprising copper sulfate, copper oxide, selenium yeast, a chelated mineral, or a combination thereof.

46. The premix dietary composition of claim 1, further comprising at least one carbohydrate comprising molasses, sugar beet pulp, sugar cane, wheat bran, wheat middlings, wheat mill run, oat hulls, grain hulls, soya hulls, peanut hulls, wood, brewery byproduct, forages, roughages, grass meal, hay meal, alfalfa meal, alfalfa, straw, algae, hay, or a combination thereof.

47. The premix dietary composition of claim 1, further comprising at least one carbohydrate obtained from at least one of a sugar, a starch, cellulose, or hemicellulose.

48. The premix dietary composition of claim 1, further comprising at least one carbohydrate obtained from at least one of wheat, corn, oats, sorghum, millet, or barley.

49. A method of preparing a premix dietary composition for ruminants, the method comprising:
combining a fatty acid component and a protein component to form a mixture;
wherein the fatty acid component comprises at least about 90% saturated fatty acid by weight and wherein the fatty acid component is present in the dietary composition in an amount of at least about 10% by weight of the dietary composition.

50. The method of claim 49, wherein combining the fatty acid component and the protein component consists of combining substantially only the fatty acid component and the protein component.

51. The method of claim 49, wherein combining the fatty acid component and the protein component consists of combining only the fatty acid component and the protein component.

52. The method of claim 49, further comprising grinding the protein component prior to combining with the fatty acid component.

53. The method of claim 49, further comprising dispersing the fatty acid component in water to obtain a liquid suspension prior to combining with the protein component.

54. The method of claim 49, further comprising dispersing the fatty acid component in water to obtain an emulsion prior to combining with the protein component.

55. The method of claim 49, further comprising heating the fatty acid component to obtain a melted fatty acid component prior to combining with the protein component.

56. The method of claim 49, further comprising drying the mixture.

57. The method of claim 49, further comprising extruding the mixture.

58. The method of claim 49, further comprising pelleting the mixture.

59. The method of claim 49, wherein the protein component comprises an oilseed meal selected from at least one of soy meal, bean meal, rapeseed meal, sunflower meal, coconut meal, olive meal, linseed meal, grapeseed meal, cottonseed meal, camelina meal, mustard seed meal, crambe seed meal, safflower meal, rice meal, or peanut meal.

60. The method of claim 49, wherein the fatty acid component comprises saturated fatty acid in an amount of at least about 90% by weight of the fatty acid component.

61. The method of claim 49, wherein the fatty acid component comprises saturated fatty acid in an amount of at least about 95% by weight of the fatty acid component.

62. The method of claim 49, wherein the fatty acid component comprises saturated fatty acid in an amount of at least about 98% by weight of the fatty acid component.

63. The method of claim 49, wherein the fatty acid component comprises a glucogenic precursor comprising glycerol, propylene glycol, molasses, propionate, glycerine, propane diol, calcium propionate, or a combination thereof.

64. The method of claim 49, further comprising combining at least one B vitamin with the mixture, wherein the at least one B vitamin comprises thiamine, riboflavin, niacin, pantothenic acid, pyridoxine, biotin, folic acid, cobalamin, choline, or a combination thereof.

65. The method of claim 49, further comprising combining at least one vitamin with the mixture, wherein the at least one vitamin comprises vitamin A, vitamin B, vitamin C, vitamin D, vitamin E, vitamin K, or a combination thereof.

66. The method of claim 49, further comprising combining at least one amino acid with the mixture, wherein the at least one amino acid comprises leucine, lysine, histidine, valine, arginine, threonine, isoleucine, phenylalanine, methionine, tryptophan, any derivative thereof, or a combination thereof.

67. The method of claim 49, further comprising combining at least one mineral with the mixture, wherein the at least one mineral comprises calcium, sodium, magnesium, potassium, phosphorus, zinc, selenium, manganese, iron, cobalt, copper, iodine, molybdenum, or a combination thereof.

68. The method of claim 49, further comprising combining a cellulosic material with the mixture.

69. A method of increasing milk fat content in ruminants, the method comprising:
combining a premix dietary composition with a feed to obtain a mixture, wherein the premix dietary composition comprises:
a fatty acid component, wherein the fatty acid component comprises at least about 90% saturated fatty acid by weight, and
a protein component,
wherein the fatty acid component is present in the dietary composition in an amount of at least about 10% by weight of the dietary composition; and
providing the mixture to a ruminant for ingestion.

70. The method of claim 69, wherein providing the dietary composition to the ruminant comprises providing about 0.5 kg to about 4 kg of dietary composition per 30 kg of weight of the ruminant to the ruminant daily.

71. The method of claim 69, wherein providing the mixture to the ruminant comprises providing the mixture to the ruminant in an amount such that the ruminant receives at least about 10 grams of fatty acid per kilogram of milk produced by the ruminant per day.

72. The method of claim 69, wherein providing the mixture to the ruminant results in at least one of an increase in production of milk by the ruminant or an increase in a fat content in the milk produced by the ruminant, relative to a similar ruminant not provided with the mixture.

73. The method of claim 69, wherein providing the mixture to the ruminant results in at least one of: an at least about 1% increase in production of milk by the ruminant or an at least about 10% increase in a fat content in the milk produced by the ruminant, relative to a similar ruminant not provided with the mixture.

74. A premix composition for ruminants, the premix composition comprising:
a fatty acid component comprising a palmitic acid compound in an amount of at least about 90% by weight of the fatty acid component; and
a protein component comprising an oilseed meal,
wherein the fatty acid component is present in the premix composition in an amount of at least about 10% by weight of the premix composition, and
wherein the premix composition is configured to be mixed with a ruminant feed and provided to ruminants.

75. The dietary composition of claim 74, wherein the fatty acid component consists essentially of the palmitic acid compound.

76. The dietary composition of claim 74, wherein the fatty acid component consists of the palmitic acid compound.
